(19) United States
(12) Patent Application Publication
(10) Pub. No.: US 2014/0070030 A1
(43) Pub. Date: Mar. 13, 2014

(54) FLUID DISCHARGE HEAD

(71) Applicant: MeadWestvaco Calmar GmbH, Hemer (DE)

(72) Inventors: Heiko Harms, Menden (DE); Gisbert Welp, Sundern (DE)

(73) Assignee: MeadWestvaco Calmar GmbH, Hemer (DE)

(21) Appl. No.: 14/115,935

(22) PCT Filed: May 16, 2012
(86) PCT No.: PCT/EP2012/002147

§ 371 Date: Nov. 6, 2013

(30) Foreign Application Priority Data
May 18, 2011 (DE) 10 2011 101 898.4

(51) Int. Cl. B05B 1/30

(52) U.S. Cl. CPC A61J 1/1475
USPC 239/583

(57) ABSTRACT

Fluid discharge head having a discharge stub (5) which has a discharge opening (6) and in which an inner sleeve (7) is arranged which has a media channel (8) and which receives a spring-loaded valve body (10) self-acting closing the discharge opening (6) by a compression spring (20), the valve body (10) being formed as a cylindrical piston, which is axially displaceable in a cylinder chamber (12) formed by the inner sleeve (7), an upper valve seat (14) and a lower valve seat (15) being provided for the piston ends (16, 17), and the valve body (10) having an intermediate valve plate (18), which forms a chamber bottom of a pressure chamber (19) which is connected to the media channel (8) and in which, in order to open the upper valve seat (14), a media discharge pressure can be set and an opening characteristic is determined by a transmission ratio of the opening diameter of cylinder chamber (12) and media inlet in the area of the lower valve seat (15), characterized in that the transmission ratio is greater than 2 and the choice of the spring stiffness of the compression spring (20) establishes the media discharge pressure in the pressure chamber (19).

The invention relates to a fluid discharge head according to the preamble of Claim 1.

WO 2009/149825 A1 discloses a fluid discharge head of the type according to the preamble, in which the problems of back-suction upon closure of the valve are eliminated by a pressure control valve. A closing guide as a flash directly after a spray discharge ensures that neither germs nor other contaminants can penetrate into the fluid discharge head through the media outlet opening. The force for opening the valve is applied directly via the medium conveyed into the discharge head. An adjustable media pressure opens the spring-loaded valve closure by moving the valve body against a spring force of a compression spring.

The medium conveyed into the fluid discharge head by means of a discharge device is led into a closed and sealed space in the cylinder chamber, from which it flows to the media outlet. The chamber provides the media outlet with a quantity of medium whose surface, in conjunction with the initial media pressure, opposes the entry of bacteria and contaminants. An advantage is that small dimensioning of the valve closure is possible.

The intermediate valve plate, on which the compression spring acts in order to press the valve body into the upper valve seat, preferably has a sealing strip to seal off the bottom of the cylinder chamber. Given a sufficient media pressure in the cylinder chamber, the bottom of which is formed by the intermediate valve plate, the upper valve seat lifts off when the force applied to the intermediate valve plate by the media pressure is greater than the spring force holding it closed. By means of the transmission ratio of the projected surface areas and of the rising pressure within the cylinder chamber, an influence can be exerted on the opening and closing behaviour.

A disadvantage, however, is that only a small media pressure increase in the pressure chamber can be set in relation to the medium conveyed into the fluid discharge head with a delivery pressure. To increase the media pressure in the pressure chamber, the delivery pressure therefore has to be increased, particularly if the spray pattern is intended to be very fine. Increased delivery pressures are generally disadvantageous and also complex.

It is therefore an object of the invention to make available a fluid discharge head which permits an improved valve closure and improves the influence on the spray pattern. The fluid discharge head should be able to be used in an equally advantageous manner for different media.

This object is achieved by the features of Claim 1.

By this means, a fluid discharge head with a valve closure is made available in which the problems of back-suction upon closing of the valve are eliminated by a pressure control valve, and the media discharge pressure in the pressure chamber can be adjusted separately from the delivery pressure of the medium delivered from a storage vessel. The chosen transmission ratio is greater, such that the media discharge pressure drops in the pressure chamber. In this way, for example, accelerated droplets can be formed as dispensing quantity, since only a small amount of energy is transferred to the medium in the pressure chamber.

With the greater transmission ratio according to the invention, the media discharge pressure can be set through the choice of the spring stiffness. Starting from a soft spring, the transmission ratio according to the invention allows an accelerated droplet to be dispensed. If this soft spring is replaced by a hard spring, a spray pattern with very fine distribution of media can then be dispensed with the same fluid discharge head. Thus, by a simple choice of spring, and with the transmission ratio according to the invention, the media discharge pressure can be set as a function of the spring stiffness of the used compression spring. With increasing spring stiffness, the media discharge pressure increases and, therefore, also the amount of energy input into the medium to be discharged. A variation in spray pattern is achieved by a variation of the spring stiffness at a chosen transmission ratio of greater than 2. Because it is possible to choose the spring stiffness, this also applies in the same advantageous manner to different media, in particular to those with differing viscosity.

Further embodiments of the invention will become clear from the following description and from the dependent claims.

The invention is explained in more detail below on the basis of the illustrative embodiment shown in the attached figures.

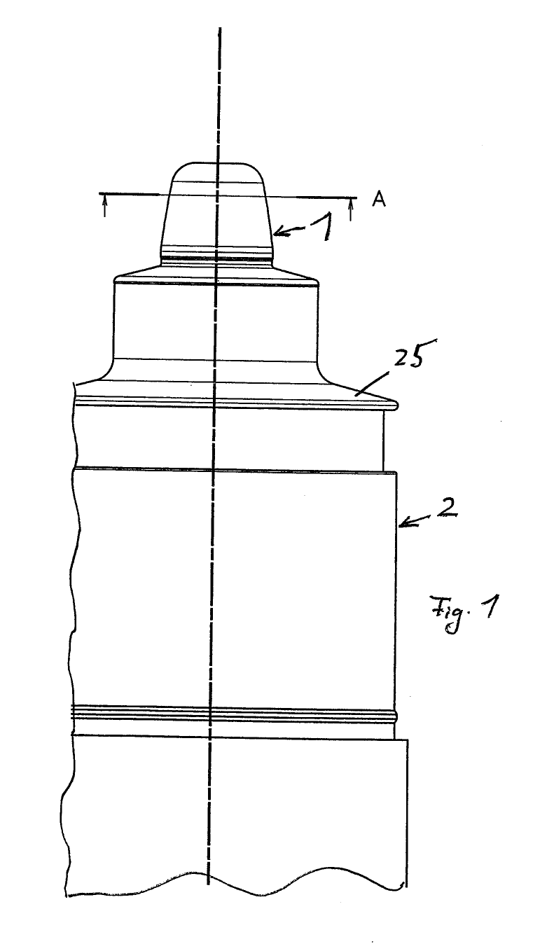

FIG. 1 shows a schematic view of a fluid discharge head,

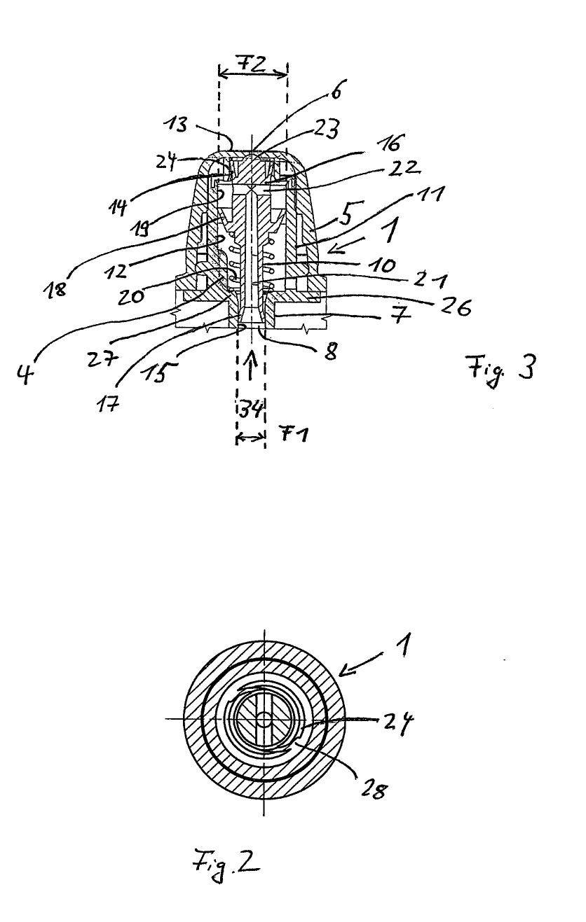

FIG. 2 shows a schematic cross section A-A according to FIG. 1,

FIG. 3 shows a schematic longitudinal section through the partial area of the fluid discharge head according to FIG. 1.

FIGS. 1 to 3 show a fluid discharge head 1 for use with a discharge device 2, the discharge device 2 comprising a media reservoir for a medium, in particular a fluid, in which the medium is placed under pressure or from which the medium is fed via a media pump, in particular a slide piston pump, to the fluid discharge head 1 with a supply pressure. The discharge device 2 has a mating piece (not shown) on which the fluid discharge head 1 can be fitted. The discharge device 2 with fitted fluid discharge head 1 forms a dispenser, in particular for liquid media.

The fluid discharge head 1 and the discharge device 2 are axially movable towards each other under spring pretensioning for the purpose of discharge actuation by shortening of the dispenser.

As FIG. 3 shows, the fluid discharge head 1 comprises a discharge stub 5 having a discharge opening 6 which is provided at the front end of the discharge stub 5. The discharge stub 5 accommodates an inner sleeve 7, which delimits a media channel 8. The media channel 8 adjoins a media guide 34 in the discharge device 2, specifically in the form of channel portions and/or media spaces adjoining one another and lying within the fluid discharge head 1. For attachment to the media guide 34, the inner sleeve 7 can have a connecting member for connection to a mating piece of the discharge device 2.

The inner sleeve 7, on the end 11 thereof directed towards the discharge opening 6, is cup-shaped in order to form a cylinder chamber 12 in conjunction with a front end 13 of the discharge stub 5. The discharge opening 6 is arranged in the front end 13. To close the discharge opening 6, the inner sleeve 7 receives a spring-loaded valve body 10 that self-acting closes the discharge opening 6. A compression spring 20 is provided for pretensioning the valve body 10 in relation to the discharge opening 6. The compression spring 20 is arranged in the cylinder chamber 12.

The valve body 10 is formed as a cylindrical piston, which is axially displaceable in the cylinder chamber 12 formed by the inner sleeve 7. The movable valve body 10 divides the cylinder chamber 12 into an upper chamber portion and a lower chamber portion. The upper chamber portion forms a pressure chamber 19, which is connected to the media channel 8 and can be opened in the direction of the discharge opening 6 and closed again under the action of the compression spring 20.

The lower chamber portion is used to receive a spring element, here the compression spring 20, which places pressure on the valve body 10, in order that the latter, as a spring-loaded valve body 10, closes the discharge opening 6 with a pretensioning force before and after actuation of the dispenser for delivery of media.

For the valve body 10, an upper valve seat 14 and a lower valve seat 15 are provided, which at the same time can serve as guide support for the piston ends 16, 17 of the valve body 10. Preferably, at least one of the two valve seats 14, 15 serves as a guide support.

The valve body 10 has an intermediate valve plate 18, which forms a chamber bottom of the pressure chamber 19 which is connected to the media channel 8 and in which, in order to open the upper valve seat 14, a media discharge pressure can be set. The intermediate valve plate 18 seals off the pressure chamber 19 with respect to the upper valve seat 14. The intermediate valve plate 18 is also preferably used to guide the movement of the valve body 10 in the cylinder chamber 12. The intermediate valve plate 18 is preferably formed as a peripheral sealing lip, which guides the valve body 10 during the upward and downward movement thereof in the cylinder chamber 12. The intermediate valve plate 18 forms a chamber bottom of the pressure chamber 19, which chamber bottom is axially movable with respect to the discharge opening 6, specifically by movement of the valve body 10. Consequently, the volume content of the pressure chamber 19 varies.

An enlargement in volume, which occurs as the valve body 10 is moved back to open the discharge opening 6, is filled by the media pressure in the media channel 8, such that no germs can penetrate. The reduction in the volume content of the pressure chamber as the discharge opening 6 is closed has the effect of providing a residual media quantum advance, which likewise prevents the entry of germs.

To open the upper valve seat 14, a media discharge pressure that is higher than a spring force of the compression spring 20 holding the valve body 10 closed can be set in the pressure chamber 19. The opening characteristic is determined by a transmission ratio of the opening diameter of cylinder chamber 12 and media inlet in the area of the lower valve seat 15. These are, according to FIG. 3, the projected surface areas F1 and F2, where F1 is determined by the valve seat 15 for the lower piston end 17 and its diameter, while F2 is determined by the diameter of the pressure chamber 19 and/or the diameter of the intermediate valve plate 18. The media inlet is formed here by the media channel 8 in the area of the lower valve seat 15.

According to the invention, the transmission ratio F2/F1 is greater than 2. Such a high transmission ratio permits a broad variation in the energy input into the pressure chamber 19, and this has an immediate effect on the dispensing shape of the medium that is to be dispensed. Dispensing shapes ranging from accelerated droplets (low energy input) to a very fine spray pattern (high energy input) is possible.

By means of the transmission ratio F2/F1 according to the invention, a structural design adjustment is chosen in which the media-induced pressure difference permits a movement of the valve body 10 at usual delivery pressures. The pressure drop generated in the cylinder chamber 12 upon actuation of the dispenser, from the delivery pressure in the media channel 8 to the media discharge pressure in the pressure chamber 19, thus has a sufficient pressure range within which, by the choice of a spring stiffness of the compression spring 20, it is possible to establish in the pressure chamber the media discharge pressure that is necessary to open the discharge opening 6, i.e. to move the valve body 10 away from its closure position shown in FIG. 3. It is thus possible, via an increase in the spring stiffness, to establish an increase in the media discharge pressure in the pressure chamber 19, i.e. the pressure that the medium in the pressure chamber 19 has to exert on the intermediate valve plate 18 in order to ensure that the latter moves away from the front end 13 of the discharge nozzle.

The compression spring 20 is inserted into the cylinder chamber 12 and is supported at one end on an underside of the intermediate valve plate 18 and a shoulder 27 of the cylinder chamber 12 adjacent to the valve seat 15. The shoulder 27 here forms the passage into the lower valve seat 15 of the media channel 8. The compression spring 20 is preferably a cylindrical helical spring which is supported at the top and bottom ends and through which a partial portion of the valve body 10 protrudes. The diameter of the compression spring 20 is smaller than the diameter of the cylinder chamber 12 in which the compression spring 20 is arranged. The cylinder chamber 12 therefore preferably has a bend protection 4 for the compression spring 20. The bend protection 4 can be a material rib, for example, on which the compression spring 20 can be supported radially.

The valve body 10 is axially displaceable, counter to the spring force of the compression spring 20, in order to open and close the upper valve seat 14. The axial (return) stroke is limited by a spring compression and the spring force rising as a result and/or by an abutment, which can be provided on the lower valve seat 15 for the lower piston end 17.

Through the cup-shaped cylinder chamber 12, the media channel 8 extends as passage-channel 21 through the valve body 10. The passage-channel 21 is preferably routed centrally through the valve body 10. The guided passage-channel 21 is preferably formed by a ascending tube section which, on the outlet side, preferably ends in an annular groove 22, which leads the passage-channel 21 over into the pressure chamber 19.

The upper piston end 16 has an outer sealing lip via which the upper piston end 16 is guided in the upper valve seat 14.

The upper valve seat 14 preferably comprises a slotted jacket 24, which is designed particularly preferably as a slotted free-standing jacket in one piece with the discharge stub 5. The upper piston end 16 is guided in the jacket 24 during the opening and closing movement. Moreover, this permits flow towards the discharge opening 6 through jacket slots 28. The upper piston end 16 lifts off with a preferably rounded sealing face 23. The jacket 24 can form a swirl chamber. The jacket 24 can be formed as an insertable component. Before the valve body 10 lifts from the upper valve seat 14, the medium is present in the pressure chamber 19 with a system pressure that is higher than the atmospheric pressure, such that, when the discharge opening 6 is opened, the medium present emerges immediately. The system pressure, which is set on the return stroke of the valve body 10 on account of the supply pressure in conjunction with the transmission ratio and the spring stiffness, corresponds to the media discharge pressure. This is preferably in a range between 1.5 and 2.3 bar.

With the discharge opening 6 opened, the valve body 10 has executed a movement away from the discharge opening 6. As a result, the sealing face 23 has lifted off. The medium present in the pressure chamber 19 with a media discharge pressure then forces its way out of the discharge opening 6 through the chamber formed between the top end of the valve body 10 and the front end 13 of the discharge stub 5. This chamber is preferably a swirl chamber. In this case, the quantity discharged is not restricted to the volume content of the pressure chamber 19, since medium is conveyed via the passage-channel 21 up to the end of a pump stroke or pressure stroke and discharged.

The inner sleeve 7 sits fixedly in the discharge stub, it being possible for the fixing to be made detachable by a snap-fit connection. The inner sleeve 7 can have an abutment 26 for the positioning thereof in the discharge stub 5.

The discharge stub 5 preferably has one or more finger contact surfaces 25 for manual actuation by application of actuating forces. The discharge stub here has the form of a nasal olive, in order to be able to be fitted as nasal adapter onto a mating piece. For other applications, the discharge stub can have other external contours.

Since accelerated droplets can also be produced according to the invention, local application is also possible, for example, in the ear, in the mouth or on the skin.

1. Fluid discharge head comprising a discharge stub which has a discharge opening and in which an inner sleeve is arranged which has a media channel and which receives a spring-loaded valve body self-acting closing the discharge opening by a compression spring, the valve body being formed as a cylindrical piston, which is axially displaceable in a cylinder chamber formed by the inner sleeve, an upper valve seat and a lower valve seat being provided for the piston ends, and the valve body having an intermediate valve plate, which forms a chamber bottom of a pressure chamber which is connected to the media channel and in which, in order to open the upper valve seat, a media discharge pressure can be set and an opening characteristic is determined by a transmission ratio of the opening diameter of cylinder chamber and media inlet in the area of the lower valve seat, wherein the transmission ratio is greater than 2 and the choice of the spring stiffness of the compression spring establishes the media discharge pressure in the pressure chamber.

2. Fluid discharge head according to claim 1, wherein an increase of the media discharge pressure in the pressure chamber can be set via an increase of the spring stiffness.

3. Fluid discharge head according to claim 1, wherein the cylinder chamber has a bend protection for the compression spring.

4. Fluid discharge head according to claim 1, wherein the cylinder chamber has a shoulder as supporting surface for the compression spring.

5. Fluid discharge head according to claim 4, wherein the upper piston end has an outer sealing lip via which the upper piston end is guided in the upper valve seat.

6. Fluid discharge head according to claim 1, wherein the upper valve seat is formed in a jacket.

7. Fluid discharge head according to claim 6, wherein the jacket is formed as a slotted free-standing jacket in one piece with the discharge stub.

8. Fluid discharge head according to claim 6, wherein the jacket is formed as an insertable component.

9. Fluid discharge head according to claim 1, wherein the intermediate valve plate seals off the pressure chamber with respect to the upper valve seat.

10. Fluid discharge head according to claim 1, wherein the intermediate valve plate is designed as a peripheral sealing lip, which guides the valve body during the upward and downward movement thereof in the cylinder chamber.

11. Fluid discharge head according to claim 1, wherein the lower valve seat holds, in a sealing manner, a piston end that broadens like a spout.

12. Fluid discharge head according to claim 1, wherein the inner sleeve has an abutment for the positioning in the discharge stub.

13. Fluid discharge head according to claim 1, wherein the cylinder chamber is cup-shaped.

14. Fluid discharge head according to claim 1, wherein the media channel extends as passage-channel through the valve body.

15. Fluid discharge head according to claim 14, wherein the passage-channel is guided centrally through the valve body.
